(19) United States
(12) Patent Application Publication
(10) Pub. No.: US 2023/0005627 A1
(43) Pub. Date: Jan. 5, 2023

(54) TRANSPIRATIONAL FIRST WALL COOLING

(71) Applicant: Tokamak Energy Ltd, Abingdon, Oxforshire (GB)

(72) Inventors: Robert Slade, Abingdon Oxfordshire (GB); Daniel Inglesias, Abingdon Oxfordshire (GB)

(21) Appl. No.: 17/782,529

(22) PCT Filed: Dec. 4, 2020
(86) PCT No.: PCT/EP2020/084737

§ 371 Date: Jun. 3, 2022

(30) Foreign Application Priority Data
Dec. 6, 2019 (GB) 1917904.3

(51) Int. Cl. G21B 1/13; F27D 1/16

(52) U.S. Cl. CPC G21B 1/13; F27D 1/1684; F27B 2005/062

(57) ABSTRACT

A first wall structure for a plasma chamber (200). The first wall structure comprises and inner wall (201) and a solid deposit (202). The inner wall is formed from a refractory metal or an alloy or composite thereof and has a plurality of pores. The solid deposit in thermal contact with the inner wall, such that the plurality of pores provide a passage from an exterior of the first wall structure to the deposit. The deposit consists of a material having a boiling point less than a melting point of the refractory metal. The first wall structure is configured such that at a normal operating temperature of the first wall structure, the deposit is solid.

### FIELD OF THE INVENTION

The present invention relates to plasma chambers. In particular, the present invention relates to a first wall structure for a plasma chamber.

### BACKGROUND

FIG. 1 is a cross section of an exemplary tokamak plasma chamber. The major components of the tokamak are a toroidal field magnet (TF) 41, and poloidal field (PF) coils 43 that magnetically confine, shape and control the plasma inside a toroidal vacuum vessel 44, and a central column 42 (which comprises the inner sections of the TF magnet, plus cooling and structural support). The tokamak further comprises shielding 45,46. The plasma is contained within the vacuum vessel 44, the interior surface of which is called the “first wall”. The vacuum vessel may have ports 47, 48 for inserting sensors or other components into the vessel, or for techniques such as neutral beam injection.

The term “first wall” may also apply to any directly plasma-facing components of the plasma chamber, for example a divertor, baffle, limiter, or covers over internal coils.

A tokamak is one kind of magnetic confinement plasma chamber—others include stellerators or spheromaks. Each kind of magnetic confinement chamber will have a similar broad principle—i.e. a vacuum chamber and one or more magnets, where the magnets produce a magnetic field which keeps the plasma within the vacuum chamber and minimises interactions with the walls.

The plasma produced in a magnetic confinement plasma chamber is prone to unstable events. Some of these put the plasma directly in contact with the walls of the plasma chamber, producing highly localized heated areas. The duration of these events is very short—lasting up to hundreds of milliseconds—but the amount of energy density deposited is enough to melt even highly robust refractory metals such as Tungsten. As well as the obvious structural issues, this is a problem in many applications as the heavy tungsten (or other refractory metal) atoms can “pollute” the plasma in the chamber, causing it to cool down.

The pollution effect can be mitigated via Itihiumisation or boronisation—coating the inside of the plasma chamber wall (the “first wall”) with a thin layer of lithium or boron, so that this will evaporate before the tungsten. However, during an unstable event, the heat will still cause structural damage to the tungsten, and the lithium or boron layer will eventually wear down.

There is therefore a need to keep the refractory metal of the first wall cool—well below its melting point—to prevent any structural damage during an unstable event, and to reduce the evaporation of heavy atoms into the plasma during such an event.

### SUMMARY

According to a first aspect, there is provided a first wall structure for a plasma chamber. The first wall structure comprises and inner wall and a solid deposit. The inner wall is formed from a refractory metal or an alloy or composite thereof and has a plurality of pores. The solid deposit in thermal contact with the inner wall, such that the plurality of pores provide a passage from an exterior of the first wall structure to the deposit. The deposit consists of a material having a boiling point less than a melting point of the refractory metal. The first wall structure is configured such that at a normal operating temperature of the first wall structure, the deposit is solid.

According to a second aspect, there is provided a magnetic confinement plasma chamber comprising a first wall structure according to the first aspect, wherein the inner wall of the first wall structure is an inner wall of the plasma chamber.

### BRIEF DESCRIPTION OF THE DRAWINGS

FIG. 1 is a cross section of a tokamak plasma chamber,

FIG. 2 is a cross section of an exemplary first wall section,

FIG. 3 shows the first wall section of FIG. 2 during an unstable event,

FIG. 4 is a cross section of a further exemplary first wall section.

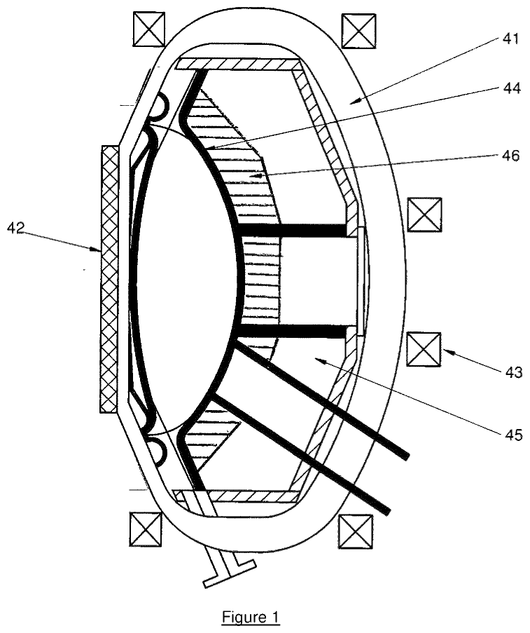

### DETAILED DESCRIPTION

The concept further described below is a first wall structure that uses transpirational cooling with lithium (or tin, or another material with a suitable melting and boiling point, as discussed later).

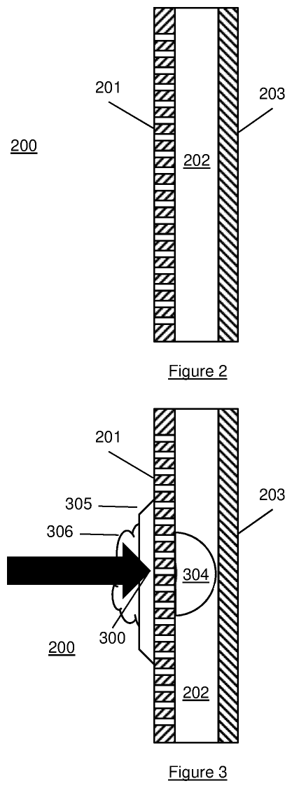

The first wall structure is illustrated in FIG. 2. FIG. 2 only shows a small section of the first wall, which is shown in cross section, and is shown flat and oriented vertically for clarity. A similar structure may be used for curved first walls, or at any desired orientation. The left hand side of the figure is the inside 200 of the plasma chamber. The first wall structure comprises an inner wall 201 made from tungsten, molybdenum, or another a refractory metal (e.g. niobium, tantalum, titanium, vanadium, chromium, zirconium, hafnium, and/or rhenium, or an alloy or composite containing a refractory metal), and having a number of pores through it. The pores provide a passage to a deposit 202, which is solid at the normal operating temperature of the first wall. The structure also comprises a back support 203, which provides structural support and prevents the deposit from leaking outside the plasma chamber.

The deposit consists of a material with a boiling point less than that of the refractory metal used for the inner wall, and a melting point greater than the temperature of the first wall during normal operation—i.e. a material which will be solid during general use of the plasma chamber, but which will boil before the inner wall metal melts if the first wall section is heated. Lithium is a promising candidate, due to its low atomic number, and will be used for the examples below, but any material having the correct melting and boiling points could be used (including compounds). In particular, the relevant melting and boiling points are those in vacuum—though in practice these are generally close to the melting and boiling points under atmospheric pressure.

FIG. 3 shows the effect of an unstable event on a section of the first wall. During the unstable event, contact 300 between the wall and the plasma on the inside 200 of the plasma chamber causes a large amount of heating. This heat is conducted by the inner wall 201 to the lithium deposit 202, which melts, forming a region of liquid lithium 304. This liquid lithium is forced out of the pores in the inner wall 201, to form a coating 305 on the surface of the inner wall. This coating may then evaporate or boil 306 due to the heat.

The latent heat of melting and vaporisation of the lithium will absorb the heat from the unstable event well before the refractory metal melts (the boiling point of lithium is 1603K, the melting points of all refractory metals are over 2000K). In addition, the use of lithium (a light element) reduces the impact of any evaporated material on the plasma. This is particularly useful for fusion applications, as lithium will form tritium and helium under bombardment by neutrons.

The structure shown in FIG. 2 will be effectively limited use—once the lithium deposit in a section of wall has melted and been evaporated away within the chamber, that section will not refill. However, this would still be suitable for short to medium term use of a plasma chamber, with occasional repair to refill the lithium deposit.

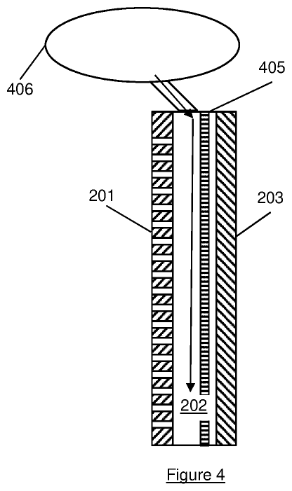

For longer term applications, a refilling system can be added as shown in FIG. 4. In addition to the inner wall 201 and lithium deposit 202, the structure of FIG. 4 comprises a heater 405, which is in thermal contact with the lithium deposit and configured to melt the lithium such that it flows, and additional liquid lithium can be added into the deposit from an external source 406 (shown schematically). The liquid lithium may be allowed to flow under gravity (with additional lithium being added from the top of the deposit), or it may be pumped into the deposit.

The addition of lithium may be done periodically, or may be done in response to the detection of an unstable event. The detection may be by plasma monitoring devices in the plasma chamber, by temperature monitoring of the first wall (e.g. by thermal sensors built into the lithium deposit, or by infra-red imaging of the first wall), or by direct monitoring of the lithium deposit (e.g. monitoring the electrical resistance, as the resistance will increase when a void is formed by the lithium melting and leaving the deposit).

The heater may be a resistance heater, a flow of hot gas, or any other suitable heating apparatus. Using a flow of hot gas is likely to simplify the design, as any electrical components can be located outside of the first wall structure, and so there is a reduced need to account for the high magnetic flux that will be experienced by the first wall. The hot gas flows through pipes in thermal contact with the lithium deposit. To further simplify the construction, the gas supply may be configured such that the flowing gas normally provides cooling to the first wall, and such that, when melting of the deposit is required, hot gas is flowed through the first wall cooling channels instead, in order to melt the deposit.

Some liquid lithium may leak out of the pores in the inner wall during the refilling process. Controlling the pressure of the liquid lithium during the refilling process may be done to reduce the leaks of lithium, or excess lithium may be allowed to flow into the reactor and collected for reprocessing (e.g. via an outlet at the bottom of the plasma vessel).

The first wall structure described above may be provided as a single unit for a plasma chamber, or may be provided as tiles which are assembled into the first wall of the plasma chamber. An intermediate solution between plasma chamber and tiles would be large solid blanket structures including first-wall, shielding, and optionally breeding functions, which are assembled inside the chamber. Similarly constructed first wall sections may be used as part of limiters, divertors or baffles within the tokamak, or as partial or full covers for components such as field coils which are within the plasma chamber.

1. A first wall structure for a plasma chamber, the first wall structure comprising:
an inner wall formed from a refractory metal or an alloy or composite thereof and having a plurality of pores;
a solid deposit in thermal contact with the inner wall, such that the plurality of pores provide a passage from an exterior of the first wall structure to the deposit, wherein the deposit consists of a material having a boiling point less than a melting point of the refractory metal;
wherein the first wall structure is configured such that at a normal operating temperature of the first wall structure, the deposit is solid.

2. A first wall structure according to claim 1, wherein the deposit comprises lithium and/or tin.

3. A first wall structure according to claim 1, further comprising a heater configured to melt the deposit, and a supply unit configured to supply additional material to the deposit.

4. A first wall structure according to claim 3, wherein the heater comprises a pipe in thermal contact with the deposit, and a gas supply unit configured to supply a hot gas to the pipe in order to melt the deposit.

5. A first wall structure according to claim 3, wherein the supply unit is configured to supply material to the top of the deposit.

6. A first wall structure according to claim 3, wherein the supply unit comprises a pump.

7. A first wall structure according to claim 3, further comprising a controller configured to activate the heater and the supply unit.

8. A first wall structure according to claim 7, further comprising a temperature sensor in thermal contact with the inner wall, wherein the controller is configured to activate the heater and the supply unit in response to the detection of a temperature greater than the melting point of the deposit.

9. A first wall structure according to claim 7, further comprising a sensor for monitoring an amount of material in the deposit, wherein the controller is configured to activate the heater and the supply unit in response to the amount of material in the deposit dropping below a threshold value.

10. A magnetic confinement plasma chamber comprising a first wall structure according to claim 1, wherein the inner wall of the first wall structure is an inner wall of the plasma chamber.

11. A plasma chamber according to claim 10, wherein the plasma chamber comprises a plurality of first wall structures according to claim 1, and wherein said structures are tiled to form the first wall of the plasma chamber.
